(19) United States
(12) Patent Application Publication
(10) Pub. No.: US 2025/0365220 A1
(43) Pub. Date: Nov. 27, 2025

(54) Techniques for continuous representation of discrete data models in a cybersecurity management system

(71) Applicant: Avalor Technologies Ltd., San Jose, CA (US)

(72) Inventors: Kfir Aharon Tishbi, Herzliya (IL); Raanan Raz, Tel Aviv (IL)

(73) Assignee: Avalor Technologies Ltd., San Jose, CA (US)

(21) Appl. No.: 18/672,456

(22) Filed: May 23, 2024

(51) Int. Cl. H04L 41/5006; H04L 41/50

(52) U.S. Cl. CPC H04L 41/5006; H04L 41/5032

(57) ABSTRACT

Continuous representation of a discrete data model representing a computing environment includes receiving a plurality of event records, each event record generated based on an event in a computing environment, the computing environment including: a resource and a principal; extracting data from the plurality of event records; generating a plurality of aggregated values from the extracted data; and generating a continuous data point between a first aggregated value and a second aggregated value, in response to receiving a request for a data point between the first aggregated value and the second aggregated value.

### TECHNICAL FIELD

The present disclosure relates generally to big data, and specifically to cybersecurity utilizations of big data in a computing environment.

### BACKGROUND

Data granularity refers to the level of detail or precision present in a dataset. In the context of big data models, several factors contribute to the loss of data granularity. Firstly, the sheer volume of data processed in big data applications necessitates aggregation and sampling techniques. Aggregation involves combining data at a higher level, leading to a loss of fine-grained details. Similarly, sampling involves selecting a subset of data points, and this subset may not fully capture the intricate details of the complete dataset.

Compression is another critical aspect in big data processing. To handle massive datasets efficiently, compression techniques are applied to represent data in a more compact form. However, compression involves removing redundancies or approximating values, which results in a loss of granularity.

Feature engineering, a common practice in preparing data for analysis or machine learning, often involves transforming or aggregating features. These transformations can lead to a loss of fine-grained details present in the original data. Additionally, data preprocessing steps, such as normalization, scaling, or dimensionality reduction, may alter the original granularity of the data.

Efficient storage solutions are crucial for managing massive datasets. Databases and storage systems may use data structures or algorithms that sacrifice granularity for scalability and performance. Moreover, parallel processing, a key technique in big data analytics, may require breaking down data into chunks for distributed processing, potentially resulting in a loss of fine details.

Cybersecurity monitoring solutions, for example, generate many alerts, events, data records, and the like, which are aggregated for easier consumption and processing. However, this aggregation leads to loss of detail.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for continuous representation of a discrete data model representing a computing environment. The method includes receiving a plurality of event records, each event record generated based on an event in a computing environment, the computing environment including: a resource and a principal; extracting data from the plurality of event records; generating a plurality of aggregated values from the extracted data; and generating a continuous data point between a first aggregated value and a second aggregated value, in response to receiving a request for a data point between the first aggregated value and the second aggregated value.

The method can further include receiving a first portion of the plurality of event records from a first source, and a second portion of the plurality of event records from a second source. The method can further include parsing the plurality of event records to extract the data. The method can further include storing only the plurality of aggregated values in a storage. The method can further include receiving a request for data including data at a first point in time; determining that the data at the first point in time is a value between the first aggregated value and the second aggregated value; and generating the continuous data point based on the first aggregated value and the second aggregated value. The method can further include generating a dashboard including a visual representation, wherein the visual representation is generated based on the first aggregated data value and the continuous data point. The method can further include generating the visual representation further based on the second aggregated data value. The method can further include applying a policy on: the first aggregated value, the second aggregated value, and a combination thereof. The method can further include determining a service level agreement (SLA) value from an SLA; and determining that the continuous data point violates the SLA in response to detecting that the continuous data point is less than the SLA value.

Certain embodiments disclosed herein also include a non-transitory computer readable medium having stored thereon causing a processing circuitry to execute the steps above. Also, certain embodiments disclosed herein also include a system that comprises: a processing circuitry; and a memory, the memory containing instructions that, when executed by the processing circuitry, configure the system to: execute the steps above.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic illustration of a computing environment utilizing a data fabric system, implemented in accordance with an embodiment.

FIG. 2 is an example data flow diagram of a data fabric system, implemented in accordance with an embodiment.

FIG. 3 is an example flowchart of a method for generating aggregated values from event records, implemented in accordance with an embodiment.

FIG. 4A is an example widget of a big data report generated based on aggregated values, utilized to describe an embodiment.

FIG. 4B is an example widget of a big data report generated based on additional aggregated values, utilized to describe another embodiment.

FIG. 5 is an example graphical user interface for generating a widget based on aggregated values, implemented in accordance with an embodiment.

FIG. 6A is an example graphical user interface for measurement determination, utilized to describe an embodiment.

FIG. 6B is an example graphical user interface for generating a new measurement from a big data system, utilized to describe an embodiment.

FIG. 7 is an example schematic diagram of a data fabric system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

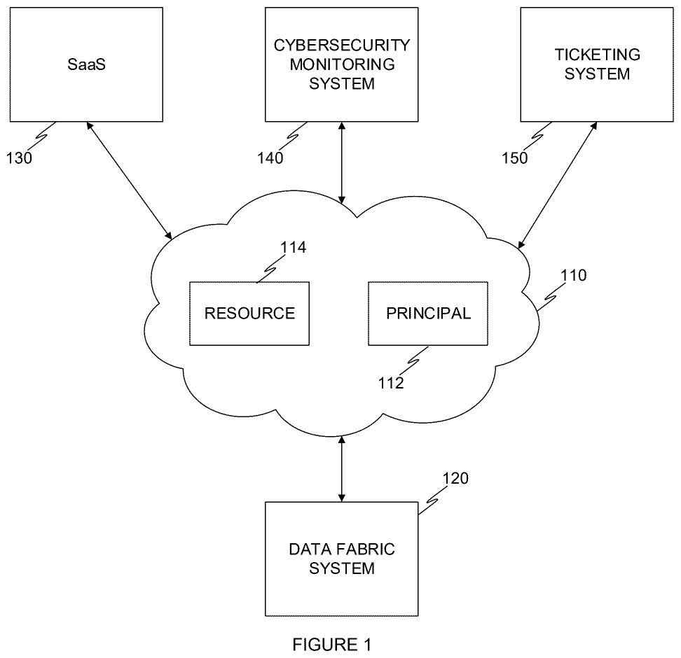

FIG. 1 is an example schematic illustration of a computing environment utilizing a data fabric system, implemented in accordance with an embodiment. In an embodiment, a computing environment 110 includes a plurality of entities. An entity is, for example, a resource 114, a principal 112, and the like.

According to an embodiment, the computing environment 110 is a networked computing environment, an on-prem computing environment, a cloud computing environment, a hybrid computing environment, a combination thereof, and the like.

In an embodiment, a cloud computing environment is deployed on a cloud computing infrastructure. For example, in an embodiment, a cloud computing environment includes a virtual private cloud (VPC), a virtual network (VNet), a virtual private network (VPN), a combination thereof, and the like. In some embodiments, a cloud computing infrastructure is Amazon® Web Services (AWS), Google® Cloud Platform, Microsoft® Azure, and the like.

In certain embodiments, a principal 112 is an entity, such as a cloud entity, which is authorized to initiate actions in the computing environment 110. In some embodiments, a principal is, for example, a user account, a service account, a user group, a role, a local account, a network account, a combination thereof, and the like.

In some embodiments, a resource 114 is an entity, such as a cloud entity, which is configured to provide access to a computing resource, an application, a hardware resource, a virtual resource, a combination thereof, and the like. For example, in certain embodiments, a resource is a virtual machine, a software container, a serverless function, an application, a service, an appliance, a gateway, a proxy server, a load balancer, a combination thereof, and the like.

In an embodiment, the computing environment 110 and components thereof (e.g., resource 114 and principal 112) are configured to generate event records. In some embodiments, an event record is generated in response to an action performed, initiated, and the like, in the computing environment 110.

In certain embodiments, the computing environment 110 is monitored by a cybersecurity monitoring system 140. In an embodiment, the cybersecurity monitoring system 140 is configured to monitor the computing environment 110, a resource 114, and the like, for cybersecurity threats, risks, misconfigurations, vulnerabilities, exposures, and the like.

In some embodiment, the cybersecurity monitoring system 140 is configured to generate alerts, tickets, and the like, in response to detecting, for example, a cybersecurity threat. A cybersecurity monitoring system 140, is for example Snyk®, Tenable® Nessus, and the like. According to an embodiment, an alert, ticket, and the like, generated by a cybersecurity monitoring system 140 based on a detection in the computing environment 110 is a data source for a data fabric system 120.

In an embodiment, the computing environment 110 is configured to receive a software as a service (SaaS) from a SaaS provider 130. In some embodiments, the SaaS provider 130 is, for example, Salesforce®, HubSpot®, Shopify®, Dropbox®, and the like. In certain embodiments, the SaaS provider 130 is configured to generate event records, alerts, and the like, and such are utilized as a data source for the data fabric system 120.

In certain embodiments, a ticket management system 150 is configured to generate a ticket, for example based on an event, an alert, a resource 114, a principal 112, and the like. In an embodiment, a ticket is a data record which is assigned to a user account, user group, and the like. In an embodiment, an alert is generated by the cybersecurity monitoring system 140, and a ticket is generated by the ticket management system 150 based on the generated alert.

In some embodiments, the data fabric system 120 is configured to receive data from a plurality of sources, such as the SaaS provider 130, the cybersecurity monitoring system 140, the ticket management system 150, the computing environment 110, a combination thereof, and the like.

In an embodiment, the data fabric system 120 is configured to generate a representation of the computing environment 110 based on data, events, alerts, tickets, combinations thereof, and the like, received from the plurality of data sources.

For example, in some embodiments, the data fabric system 120 is configured to receive data from multiple sources regarding a resource (e.g., static analysis data from the cybersecurity monitoring system 140, API query from the computing environment 110, etc.).

In certain embodiments, the data fabric system 120 is configured to receive a plurality of event records, and extract data from the received event records. In some embodiments, the data fabric system 120 is configured to generate an aggregated value based on the extracted data. In an embodiment, the data fabric system 120 is further configured to generate a continuous value between a first aggregated value and a second aggregated value.

In an embodiment, the data fabric system 120 is configured to generate a measurement based on the extracted data. In some embodiments, the measurement includes a plurality of values, a plurality of aggregated values, a combination thereof, and the like. In an embodiment, the data fabric system 120 is further configured to generate a statistical model based on the plurality of values, the plurality of aggregated values, a combination thereof, and the like. In an embodiment, the data fabric system 120 is configured to utilize the statistical model to generate the continuous value (e.g., a continuous data point).

For example, in an embodiment, a linear regression is utilized to determine a fit of a statistical model from a plurality of predetermined statistical models for the plurality of values. In some embodiments, the data fabric system 120 is configured to generate a prompt for a large language model (LLM), which when executed configures the LLM to output the continuous value.

For example, in an embodiment, the prompt is generated based on a template which is modified using a first aggregated value, a second aggregated value, a combination thereof, and the like. In some embodiments, a first aggregated value is a measurement at a first time, a second aggregated value is a measurement at a second time, and the requested continuous value (e.g., the output of the LLM when executing the generated prompt) represents a value at a third time which is between the first time and the second time.

According to an embodiment, generating a continuous value allows storing aggregated values instead of discrete values (thus reducing storage), and then generating the continuous value in response for a request for the continuous value.

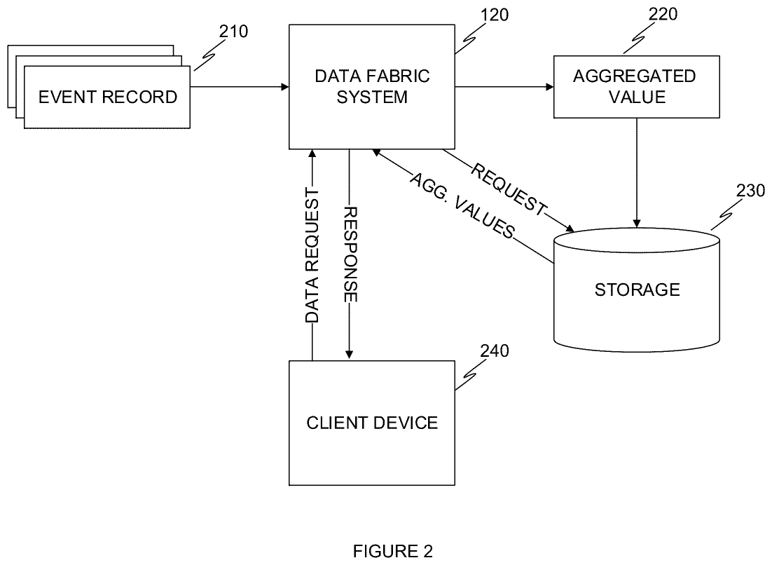

FIG. 2 is an example data flow diagram of a data fabric system, implemented in accordance with an embodiment. In an embodiment, a data fabric system 120 is configured to receive a plurality of event records 210. In some embodiments, the plurality of event records 210 includes records of different types. A record type is, for example, a log, a cloud log, a network log, an identity type, an alert, a ticket, a record from a bucket, a combination thereof, and the like. For example, in an embodiment, a record is pulled from, received from, and the like, Amazon® Cloudtrail.

In some embodiments, a portion of event records of the plurality of event records 210 are received from a first source, and a second portion of event records of the plurality of event records are received from a second source. In an embodiment, a source, data source, and the like, is a SaaS provider, a cybersecurity monitoring system, a ticket management system, a computing environment, an API of a cloud computing infrastructure, a bucket, a combination thereof, and the like.

In an embodiment, the data fabric system 120 is configured to generate a measurement, such as an aggregated value 220. For example, in an embodiment, the data fabric system 120 is configured to receive a plurality of events, and generate an aggregate value 220 corresponding to the number of events of a first type, a number of events of a second type, etc.

In certain embodiments, the data fabric system 120 is configured to store the aggregated value 220 in a storage 230. In an embodiment, the storage 230 is a cloud computing storage system, a distributed storage system, a combination thereof, and the like. In some embodiments, the data fabric system 120 is configured to store only aggregated values, measurements, metadata, and the like, in the storage 230. In an embodiment, such storage excludes storing the plurality of event records 210.

According to an embodiment, the data fabric system 120 is configured to receive a data request from a client device 240. In an embodiment, the data fabric system 120 is configured to provide the client device 240 with a graphical user interface, a report, and the like. For example, in some embodiments, the data fabric system 120 is configured to generate a visual representation of data, such as a widget, discussed in more detail below, and provide such a visual representation to the client device 240 in response to receiving a request for data.

In an embodiment, the data request includes a request for a data measurement, a data value, and the like, at a first point in time, at a range of time, etc. In an embodiment, the data fabric system 120 is configured to determine a plurality of aggregated values, aggregated measurements, metadata, and the like, and retrieve the same from the storage 230. In an embodiment, the data fabric system 120 is configured to perform such a determination based on the request.

In some embodiments, the data fabric system 120 is configured to receive from the storage 230 the aggregated values, aggregated measurements, a combination thereof, and the like, and generate from the aggregated value, for example, a continuous data point, e.g., a data point having a value which is based on an aggregated value at a first point in time, and an aggregated value at a second point in time.

For example, in an embodiment, a first aggregated value corresponds to a measurement of 50 event records of a first type (e.g., critical errors) at a first hour, and a second aggregated value corresponds to a measurement of 100 event records of the first type at a second hour. In some embodiments, the data fabric system 120 is configured to determine a statistical model, in this example indicating that there is a linear correlation.

In some embodiments, in response to receiving a request to plot a data point of a number of critical errors at a time of one and a half hours (i.e., between the first time and the second time), the data fabric system 120 is configured to generate a value of 75. In an embodiment, this response is provided to the client device 240.

In certain embodiments, an identity verification is performed between an identity utilized by the client device 240 and the data fabric system 120. In some embodiments, aggregated values, responses, and the like, are provided to the client device 240 based on a permission associated with the identity utilized by the client device 240.

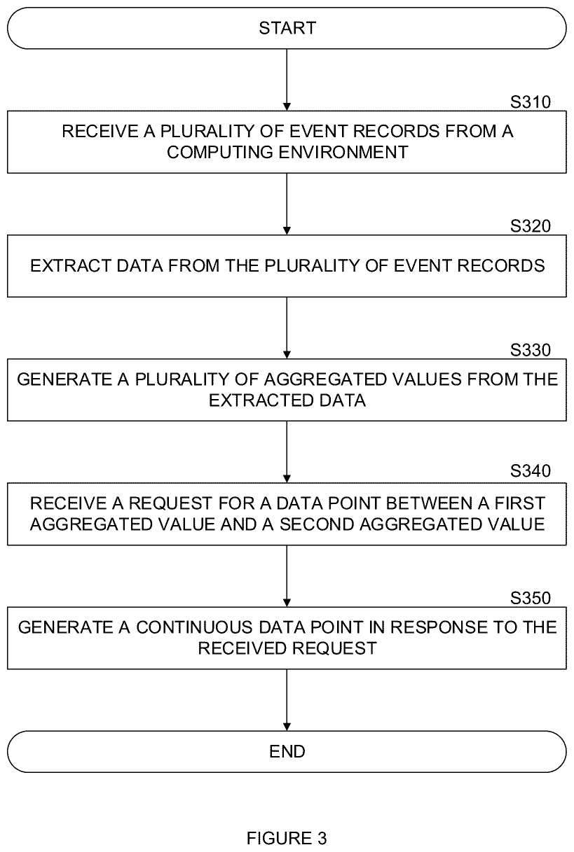

FIG. 3 is an example flowchart of a method for generating aggregated values from event records, implemented in accordance with an embodiment.

At S310, a plurality of event records are received. In an embodiment, receiving an event record includes accessing a storage, a cloud based storage system, a distributed storage system, a data stream, a combination thereof, and the like.

In some embodiments, the plurality of event records are received from a plurality of data sources. In an embodiment, a data source is a SaaS provider, a cybersecurity monitoring system, a ticket management system, a cloud computing API, a combination thereof, and the like.

At S320, data is extracted from an event record. In an embodiment, an event record is parsed to extract data therefrom. In some embodiments, data is extracted from an event record based on a predetermined data schema. In an embodiment, extracting data includes identifying a data field in an event record, and extracting a value corresponding to the data field.

In an embodiment, an event record includes a data field such as an identity identifier, an IP address, an identifier of a resource, an indicator of an alert, an alert type, a ticket type, an alert severity, a time stamp, a combination thereof, and the like.

At S330, a measurement is generated. In an embodiment, a measurement is generated for an aggregated value. In some embodiments, a plurality of measurements, aggregated values, combination thereof, and the like, are generated. According to an embodiment, a plurality of measurements includes a plurality of measurements of a first type, a plurality of measurements of a second type, etc.

For example, in an embodiment, a first measurement of a first type is generated based on event records of a first type received at a first time window, and a second measurement of the first type is generated based on event records of the first type received at a second time window.

In an embodiment, metadata is generated based on the data extracted from the event records. According to an embodiment, metadata includes a statistical model utilized to predict a value, a plurality of values, and the like, based on the metadata, a time point, an aggregated value, a measurement, a combination thereof, and the like.

In some embodiments, the measurements, aggregated values, metadata, and the like, are stored in a storage, such as a cloud computing storage, a distributed storage, a combination thereof, and the like.

At S340, a request for data is received. In an embodiment, requests are received continuously, periodically, a combination thereof, and the like. For example, in an embodiment, a first request for data is received originating from a first source (e.g., a first client device), and a second request for data is received originating from a second source (e.g., a second client device).

In an embodiment, the request includes an indicator of a data type, a measurement type, a measurement identifier, an identity identifier, a credential, a combination thereof, and the like. In some embodiments, a response to the request is generated based on the identity identifier, the credential, a combination thereof, and the like.

At S350, a continuous data point is generated. In an embodiment, the data point is generated in response to the request for data. In some embodiments, the continuous data point is generated based on a statistical model, an LLM output, a combination thereof, and the like. In an embodiment, the continuous data point is generated from an aggregated value, a measurement, a combination thereof, and the like.

In an embodiment, a continuous data point includes a value which is not stored in the storage. In some embodiments, it is advantageous to store aggregate values, measurements, and the like, to reduce the stored data, and generate such values ad hoc, as they are needed.

In an embodiment, the continuous data point is generated based on a statistical model and: a measurement, an aggregated value, a combination thereof, and the like. In certain embodiments, the continuous data point is generated based on an LLM. For example, in an embodiment, a prompt is generated for an LLM which when processed by the LLM generates an output including the continuous data point.

In some embodiments, the prompt is modified based on a predetermined template. In an embodiment, the predetermined template is modified based on the received request, a measurement, an aggregated value, a data schema, a combination thereof, and the like.

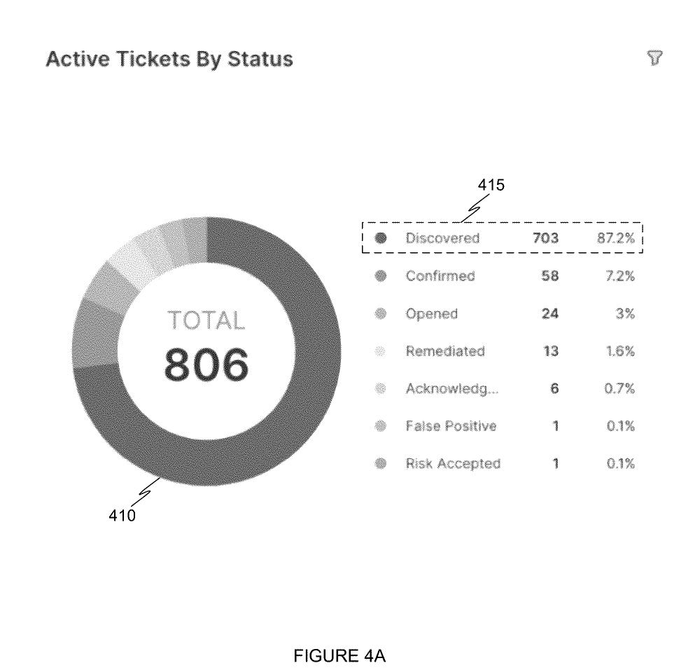

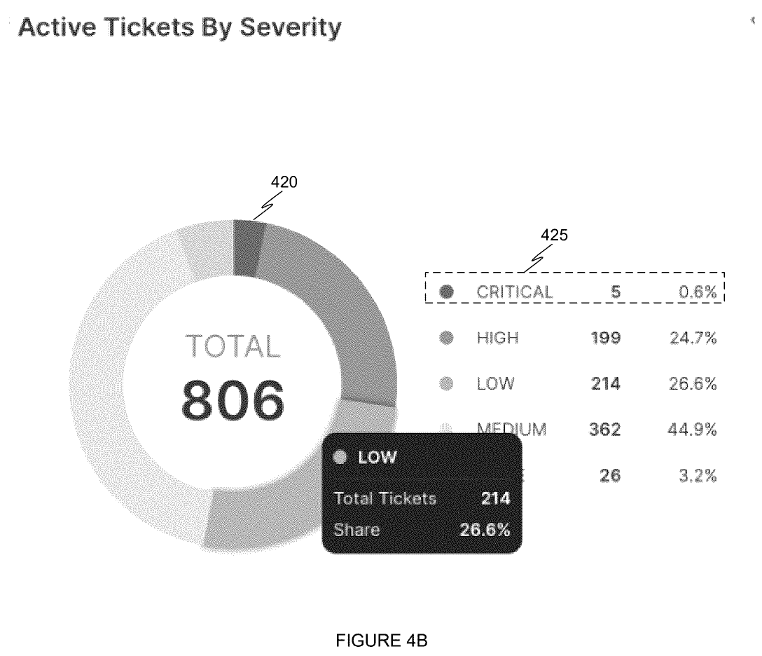

FIG. 4A is an example widget of a big data report generated based on aggregated values, utilized to describe an embodiment. According to an embodiment, a widget includes a visual representation 410 of data, in this example of a chart of data. In an embodiment, the chart includes a measurement 415 indicating a number of tickets of a first type (i.e., discovered tickets), a value (e.g., 703), and a percentage of the measurement as a total of an aggregated value of measurements (e.g., 87.2%).

In an embodiment, the visual representation 410 includes a graphical element which is rendered based on a value of the measurement 415, and a plurality of values of a plurality of measurements.

FIG. 4B is an example widget of a big data report generated based on additional aggregated values, utilized to describe another embodiment. In an embodiment, the widget includes a visual representation 420, such as a graphical element, which represents a plurality of measurement values.

In an embodiment, a first measurement 425 represents a number of active tickets by severity (e.g., critical), and includes a value (e.g., 5), and a percentage (e.g., 0.6%) as a number of total active tickets, where total active tickets is an aggregate value of a plurality of measurement values, each measurement value corresponding to a different condition of severity.

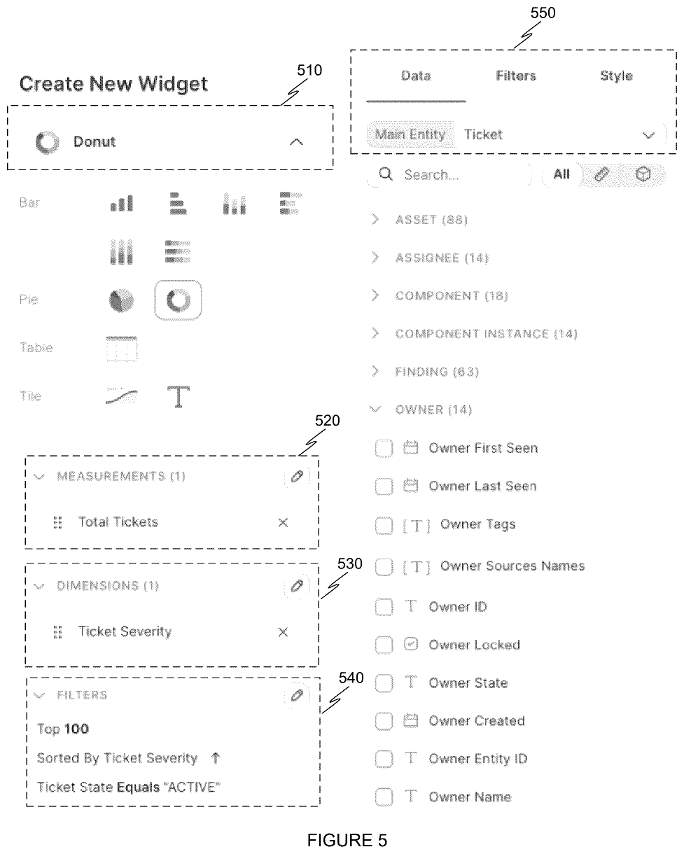

FIG. 5 is an example graphical user interface for generating a widget based on aggregated values, implemented in accordance with an embodiment. In an embodiment, a graphical user interface (GUI) includes graphical elements which a user using a user device can interact with.

In an embodiment, a first graphical element 510 is configured to receive an input indicating a type of visual representation to generate for a widget. For example, in an embodiment, a visual representation is a bar chart, a pie chart, a table, a graph, a combination thereof, and the like.

In some embodiments, a second graphical element 520 is configured to receive an input indicating a measurement. In certain embodiments, a plurality of measurements are selected as an input. In an embodiment, a measurement is, for example, a total number of tickets.

According to an embodiment, a third graphical element 530 is configured to receive an input indicating a dimension of the measurement. For example, in an embodiment, the dimension of the measurement selected utilizing the second graphical element 520 is a dimension of ‘ticket severity’. In some embodiments, an aggregated value is generated based on a dimension of a measurement, based on the measurement, a combination thereof, and the like.

In an embodiment, a fourth graphical element 540 is configured to receive an input indicating a filter. For example, according to an embodiment, a filter has a value of ‘active’, such that only active tickets are selected. In some embodiments, a filter is based on a value, a plurality of values, and the like, of an event record, of an aggregated value, of a measurement, of a combination thereof, and the like.

In certain embodiments, a fifth graphical element 550 is configured to receive an input indicating an additional filter, an additional dimension, an additional measurement, a combination thereof, and the like, utilized to represent data by the widget.

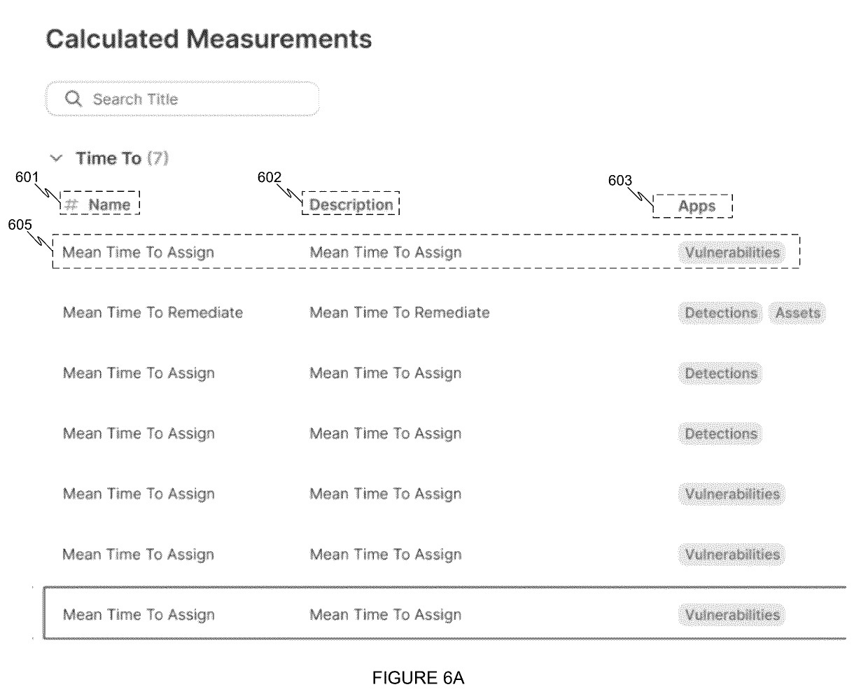

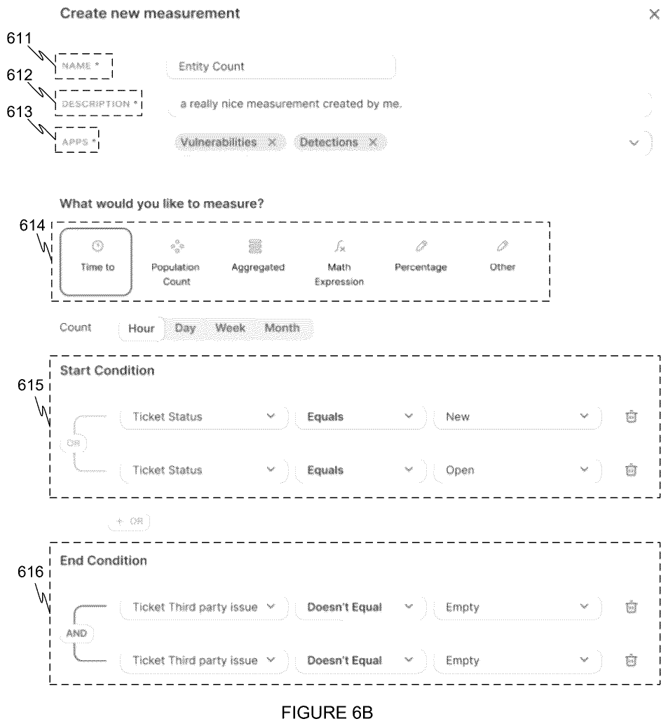

FIG. 6A is an example graphical user interface for measurement determination, utilized to describe an embodiment. In an embodiment, the graphical user interface (GUI) includes a plurality of graphical elements which are utilized to receive and display inputs for generating measurements based on data received from multiple data sources respective of a single computing environment.

According to an embodiment, a measurement includes a name identifier 601, a description 602, and an associated application 603. In an embodiment, a plurality of associated applications utilize a measurement.

For example, in an embodiment, a first measurement 605 has a name identifier of ‘mean time to assign’, indicating that the first measurement 605 indicates a mean time for assigning a ticket to a user account, user group, and the like, which is authorized to resolve the ticket.

In some embodiments, the first measurement 605 further includes a description, which is a textual description of the first measurement 605, and an associated application. In certain embodiment, the associated applications are widgets which utilize the measurement.

This is advantageous, in an embodiment, as a measurement is utilized to generally generate points of data from different sources, different event records, etc., and it is useful for example, to determine what applications utilize such a measurement. For example, it is useful to know if a measurement is at all being utilized, and further useful to know that if a measurement is changed, the impact on applications can be readily ascertained by performing a lookup of the associated applications.

FIG. 6B is an example graphical user interface for generating a new measurement from a big data system, utilized to describe an embodiment. According to an embodiment, a graphical user interface (GUI) includes a plurality of graphical elements which are configured to receive an input utilized to generate a new measurement.

In an embodiment, a first graphical element 611 is configured to receive an input indicating a name, an identifier, and the like, of the new measurement. In some embodiments, a constraint is placed on the input, such that each measurement is provided with a unique name, identifier, and the like.

In some embodiments, a second graphical element 612 is configured to receive an input which is a description of the generated measurement. In an embodiment, the input is a textual input.

In certain embodiments, a third graphical element 613 is configured to receive an input including an identifier of an application utilizing the measurement. In some embodiments, a plurality of application identifiers are received. In an embodiment, the identifier indicates that an application is authorized to access the measurement.

According to an embodiment, a fourth graphical element 614 is configured to receive an input selection of a measurement type. In an embodiment, a measurement type is a ‘time to’, a ‘population count’, an aggregation, a custom mathematical expression, a percentage, a combination thereof, and the like.

In some embodiments, a fifth graphical element 615 is configured to receive an input for a start condition of the measurement. In an embodiment, a sixth graphical element 616 is configured to receive an input for an end condition of the measurement.

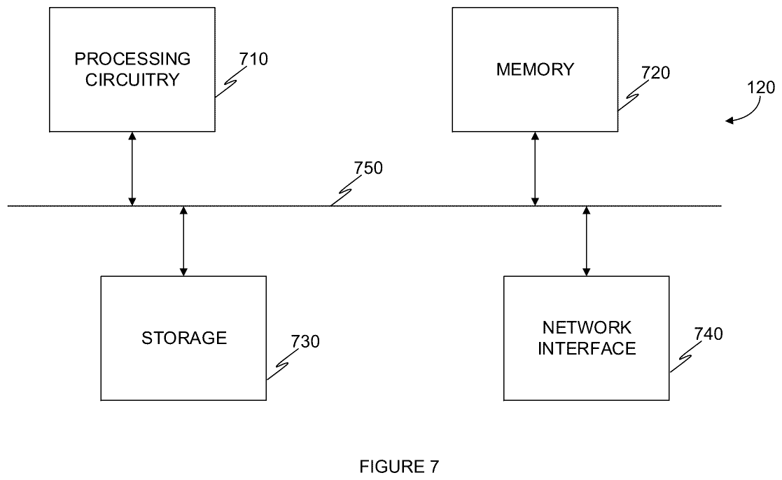

FIG. 7 is an example schematic diagram of a data fabric system 120 according to an embodiment. The data fabric system 120 includes, according to an embodiment, a processing circuitry 710 coupled to a memory 720, a storage 730, and a network interface 740. In an embodiment, the components of the data fabric system 120 are communicatively connected via a bus 750.

In certain embodiments, the processing circuitry 710 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 720 is a volatile memory (e.g., random access memory, etc.), a non-volatile memory (e.g., read only memory, flash memory, etc.), a combination thereof, and the like. In some embodiments, the memory 720 is an on-chip memory, an off-chip memory, a combination thereof, and the like. In certain embodiments, the memory 720 is a scratch-pad memory for the processing circuitry 710.

In one configuration, software for implementing one or more embodiments disclosed herein is stored in the storage 730, in the memory 720, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 710, cause the processing circuitry 710 to perform the various processes described herein, in accordance with an embodiment.

In some embodiments, the storage 730 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 740 is configured to provide the data fabric system 120 with communication with, for example, the computing environment 110, the cybersecurity monitoring system 140, the ticketing system 150, and the like, according to an embodiment.

It should be understood that the embodiments described herein are not limited to the specific architecture illustrated in FIG. 7, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for continuous representation of a discrete data model representing a computing environment, comprising:
receiving a plurality of event records, each event record generated based on an event in a computing environment, the computing environment including: a resource and a principal;
extracting data from the plurality of event records;
generating a plurality of aggregated values from the extracted data; and
generating a continuous data point between a first aggregated value and a second aggregated value, in response to receiving a request for a data point between the first aggregated value and the second aggregated value.

2. The method of claim 1, further comprising:
receiving a first portion of the plurality of event records from a first source, and a second portion of the plurality of event records from a second source.

3. The method of claim 1, further comprising:
parsing the plurality of event records to extract the data.

4. The method of claim 1, further comprising:
storing only the plurality of aggregated values in a storage.

5. The method of claim 1, further comprising:
receiving a request for data including data at a first point in time;
determining that the data at the first point in time is a value between the first aggregated value and the second aggregated value; and
generating the continuous data point based on the first aggregated value and the second aggregated value.

6. The method of claim 1, further comprising:
generating a dashboard including a visual representation, wherein the visual representation is generated based on the first aggregated data value and the continuous data point.

7. The method of claim 6, further comprising:
generating the visual representation further based on the second aggregated data value.

8. The method of claim 1, further comprising:
applying a policy on: the first aggregated value, the second aggregated value, and a combination thereof.

9. The method of claim 1, further comprising:
determining a service level agreement (SLA) value from an SLA;
determining that the continuous data point violates the SLA in response to detecting that the continuous data point is less than the SLA value.

10. A computing environment for continuous representation of a discrete data model representing a computing environment, the computing environment comprising processing circuitry configured to:
receive a plurality of event records, each event record generated based on an event in a computing environment, the computing environment including: a resource and a principal;
extract data from the plurality of event records;
generate a plurality of aggregated values from the extracted data; and
generate a continuous data point between a first aggregated value and a second aggregated value, in response to a request for a data point between the first aggregated value and the second aggregated value.

11. The computing environment of claim 10, wherein the processing circuitry is further configured to:
receive a first portion of the plurality of event records from a first source, and a second portion of the plurality of event records from a second source.

12. The computing environment of claim 10, wherein the processing circuitry is further configured to:
parse the plurality of event records to extract the data.

13. The computing environment of claim 10, wherein the processing circuitry is further configured to:
store only the plurality of aggregated values in a storage.

14. The computing environment of claim 10, wherein the processing circuitry is further configured to:
receive a request for data including data at a first point in time;
determine that the data at the first point in time is a value between the first aggregated value and the second aggregated value; and
generate the continuous data point based on the first aggregated value and the second aggregated value.

15. The computing environment of claim 10, wherein the processing circuitry is further configured to:
generate a dashboard including a visual representation, wherein the visual representation is generated based on the first aggregated data value and the continuous data point.

16. The computing environment of claim 15, wherein the processing circuitry is further configured to:
generating the visual representation further based on the second aggregated data value.

17. The computing environment of claim 10, wherein the processing circuitry is further configured to:
applying a policy on: the first aggregated value, the second aggregated value, and a combination thereof.

18. The computing environment of claim 10, wherein the processing circuitry is further configured to:
determining a service level agreement (SLA) value from an SLA;
determining that the continuous data point violates the SLA in response to detecting that the continuous data point is less than the SLA value.

19. A non-transitory computer-readable medium for continuous representation of a discrete data model representing a computing environment, the non-transitory computer-readable comprising instructions that, when executed, cause processing circuitry to execute steps of:
receiving a plurality of event records, each event record generated based on an event in a computing environment, the computing environment including: a resource and a principal;
extracting data from the plurality of event records;
generating a plurality of aggregated values from the extracted data; and
generating a continuous data point between a first aggregated value and a second aggregated value, in response to receiving a request for a data point between the first aggregated value and the second aggregated value.

20. The non-transitory computer-readable medium of claim 19, wherein the steps further include:
receiving a first portion of the plurality of event records from a first source, and a second portion of the plurality of event records from a second source.
